(19) United States
(12) Patent Application Publication
(10) Pub. No.: US 2022/0227271 A1
(43) Pub. Date: Jul. 21, 2022

(54) HEATING SYSTEM, AND VEHICLE SEAT COMPRISING A HEATING SYSTEM

(71) Applicant: GENTHERM GMBH, Odelzhausen (DE)

(72) Inventor: Peter Tremmel, Aichach (DE)

(21) Appl. No.: 17/614,681

(22) PCT Filed: Jun. 8, 2020
(86) PCT No.: PCT/DE2020/000126

§ 371 Date: Nov. 29, 2021

(30) Foreign Application Priority Data
Jun. 12, 2019 (DE) 10 2019 004 101.1

(51) Int. Cl. B60N 2/56; H05B 3/34

(52) U.S. Cl. CPC B60N 2/5685; H05B 3/342; H05B 2203/029; H05B 2203/011; H05B 2203/014; H05B 2203/003

(57) ABSTRACT

A heating device that includes at least one heating element, at least one electrode element, and a substrate on which the at least one electrode element and the at least one heating element are arranged. The at least one electrode element is arranged in a path and the at least one heating element is arranged in another path that is different than the path of the at least one electrode element. The path of the at least one electrode element intersects the path of the at least one heating element in at least one contact zone. The at least one electrode element and the at least one heating element in the at least one contact zone are electrically conductively connected to one another.

### CROSS-REFERENCE TO RELATED APPLICATIONS

This application is a US National Stage Entry of PCT/DE2020/000126 filed on Jun. 8, 2020, which claims the benefit of DE 10 2019 004 101.1 filed on Jun. 12, 2019, all of which are hereby incorporated by reference herein for all purposes.

### FIELD

The present invention relates to a heating device, preferably for vehicle seats, and a vehicle seat comprising such a heating device.

### BACKGROUND

Textile heating elements having heating elements made of carbon fibers have been known for a long time and can be used to heat vehicle seats. Typically, such heaters have strip-shaped electrodes which are attached to a substrate material. A plurality of heating elements are arranged as heating resistors between said electrodes and are electrically contacted by the electrodes.

Such heating elements are expensive due to the electrodes and their geometric design is limited.

Electrical contact between the heating elements and electrodes has so far been ensured by typically using a plurality of electrode elements per electrode, fixing said electrode elements as an electrode tape as a strip on the substrate material. Due to the high costs associated with the hitherto necessary use of a plurality of electrodes to ensure reliable electrical contact, heating devices are desirable when they can be produced with less economic effort and still ensure reliable electrical contact. The requirement for a plurality of electrodes also limits flexibility in vehicle seat design.

### SUMMARY

An object of the invention can therefore be seen in providing a heating device and a vehicle seat comprising such a heating device, which are characterized by lower manufacturing costs and are still reliable with regard to the electrical contact of carbon fiber heating resistors. In addition, the heating device should, if possible, be designed to be flexible or be able to be easily relocated in vehicle seats.

One aspect of the invention relates to a heating device (1), comprising
at least one heating element (6a, 6b, 6c),
at least one electrode element (4a, 4b),
and at least one substrate (2) on which at least one such electrode element (4a, 4b) and at least one such heating element (6a, 6b, 6c) are arranged,
wherein said electrode element (4a, 4b) and said heating element (6a, 6b, 6c) are arranged on different paths on the substrate (2),
wherein the paths of the electrode element (4a, 4b) and the heating element (6a, 6b, 6c) intersect in at least one contact zone (5a, 5b), and
wherein the electrode element (4a, 4b) and the heating element (6a, 6b, 6c) in the contact zone (5a, 5b) are electrically conductively connected to one another at a common contact surface.

It is advantageous when the electrode element (4a, 4b) and the heating element (6a, 6b, 6c) intersect at least twice in order to achieve contact between the two elements at multiple points in the contact zone (5a, 5b) and to increase the contact surface overall that is common to both elements.

What is desirable for the flexibility of the heating element is
the heating element is a flat structure, or
the substrate is at least partially made of textile (particularly fleece), foam and/or film.

Also desirable for the flexibility of the heating device is
at least one heating element is formed by an at least partially electrically conductive strand,
at least one electrode element is formed by an at least partially electrically conductive strand.

What is desirable for a homogeneous heating effect is
at least one heating element has a plurality of electrically conductive filaments arranged parallel to one another, twisted with one another and/or one after the other in the heating element, particularly carbon fibers, particularly
at least one electrode element has a plurality of electrically conductive filaments arranged parallel to one another, twisted with one another and/or one after the other in the electrode element.

What can have a cost-saving effect,
the heating device (1) has two electrodes,
which are spaced apart from one another on the substrate,
which span a heating zone between them and
which are electrically connected to one another via a plurality of heating elements,
wherein at least one electrode is formed from a single electrode element.

It is advantageous for the homogeneity of the heating effect when a plurality of contact zones is provided between at least one electrode element or an electrode on the one hand and a plurality of heating elements along the electrode element on the other hand.

Efficient production results when at least one heating element has only two contact zones, preferably in the region of its respective ends, this preferably applying to at least 50% of all heating elements provided on a substrate.

Reliable strain relief results when at least one electrode element (4a, 4b) runs in a meandering shape in the at least one contact region (5a, 5b) along a longitudinal direction of the respective heating element (6a, 6b, 6c).

Cost-effective production results when exactly two electrode elements (4a, 4b) are attached to the substrate (2) in a heating device and which comprise a plurality of heating elements, particularly carbon fiber heating resistors (6a, 6b, 6c), wherein it is provided that the exactly two electrode elements (4a, 4b) attached to the substrate are electrically conductively connected to the plurality of heating elements (6a, 6b, 6c) over a respective contact region (5a, 5b).

Reliable strain relief results when the at least one electrode element (4a, 4b) in a heating device runs at least approximately in a straight line or at least approximately sinusoidally shape in a section adjoining the at least one contact region (5a, 5b).

Reliable strain relief also results when, in a heating device, at least one electrode element (4a, 4b) is attached to the substrate (2) over at least one contact region (5a, 5b).

Inexpensive production results when, in a heating device, at least one electrode element (4a, 4b) is sewn onto the substrate (2) over at least one contact region (5a, 5b).

A good current-carrying capacity is obtained when at least one electrode element (4a, 4b) in a heating device consists of copper or an alloy.

A particularly fail-safe construction results when at least one electrode element (4a, 4b) in a heating device is formed by a plurality of filaments, each of which consists of a copper alloy, wherein
said electrode element (4a, 4b) has a number n of filaments, for which number n applies: 5≤n≤125, preferably 5-40, particularly 20≤n≤40, preferably 20-25, ideally 20, and/or
each of these filaments has a cross-sectional diameter d, for which the following applies: 0.03 mm≤d≤0.12 mm

A particularly energy-efficient construction results from a heating device comprising a power source and/or a transformer which are connected to the at least two electrodes (4a, 4b) attached to the substrate and which provide a nominal voltage of 48 volts.

A further aspect of the invention relates to a vehicle seat (10), comprising a seat cushion (12), a backrest (14) and a heating device (1) according to the invention, wherein it is provided that that the substrate (2), at least two electrode elements (4a, 4b) or electrodes attached to the substrate (2) and at least one heating resistor (6a, 6b, 6c) having carbon fiber components are embedded in the seat cushion (12) and/or in the backrest (14).

It is also conceivable for the heating device to be used in further components of a vehicle or a passenger vehicle. In practice, it can be the case, for example, that the heating device is designed as part of a steering wheel. The heating device can also be designed as part of further components of a vehicle or passenger vehicle in order to optionally control the temperature of an interior of the respective vehicle or passenger vehicle.

At least one heating element is part of the heating device. In preferred embodiments, however, the heating device can comprise a plurality of carbon fiber heating resistors which run between the at least two electrodes fastened to the substrate or which are arranged between the at least two electrodes attached to the substrate. The at least one heating element can run with a plurality of reversals or curves between the at least two electrodes, whereby the heating output of the heating device can be improved compared to a straight course of the at least one heating element.

The at least two electrodes attached to the substrate are electrically conductively connected to a respective heating element over a respective contact region. Particularly, it can be the case here that a respective heating element rests on the at least two electrodes attached to the substrate. Embodiments in which a respective heating element is in surface contact with the at least two electrodes attached to the substrate have thus also proven successful. If the heating device is designed as a part of a vehicle seat described below, it is possible that a respective heating element is located above the at least two electrodes attached to the substrate with regard to a side of the vehicle seat facing the user. The at least two electrodes attached to the substrate can thus be arranged between the substrate and the at least one heating element.

At least one electrode has a defined course in at least one contact region, from which defined course the at least one electrode increases in area along a longitudinal direction of the respective heating element. This makes it possible to ensure in a simple manner that an electrical connection between the electrodes and a respective heating element is formed with a high degree of safety and reliability even with a reduced number of electrodes compared to the prior art. Embodiments have proven successful in which the at least one electrode runs in a meandering shape or meandering manner in the at least one contact region along a longitudinal direction of the respective heating element. In addition, it can be the case, for example, for the at least one electrode to be oriented in a spiral shape in the at least one contact region or for the at least one electrode to run in a spiral shape in the at least one contact region. However, the invention is not limited to said embodiments, so that further courses may be considered, by means of which the at least one electrode can increase in area in the longitudinal direction of the respective carbon fiber heating resistor.

Exactly two electrodes can be attached to the substrate. The heating device can also comprise a plurality of heating resistors made of or with carbon fibers. One possibility is that the exactly two electrodes attached to the substrate are electrically conductively connected to the plurality of carbon fiber heating resistors via a respective contact region. Such heating devices have a very simple structure and are very inexpensive to produce, wherein safe and reliable electrical contact between the electrodes or the exactly two electrodes and the plurality of carbon fiber heating resistors is still guaranteed.

The at least one electrode can be attached to the substrate via at least one contact region. Here, the at least one electrode can be sewn onto the substrate over at least one contact region. It is conceivable for the at least one electrode to be fastened to the substrate or sewn onto the substrate over all of the contact regions. All electrodes designed as part of the heating device can also be fastened to the substrate or sewn onto the substrate over the contact region.

The vehicle seat can, for example, be made up of a plurality of layers, wherein at least one layer consists of foamed material. The substrate, the at least two electrodes attached to the substrate and the at least one heating element can be inserted or introduced into a recess which provides a layer of foamed material or which is formed by a layer of foamed material.

### BRIEF DESCRIPTION OF THE FIGURES

In the following, the invention and its advantages are to be explained in more detail with reference to the accompanying figures.

FIG. 1 shows a schematic view of an embodiment of a heating device according to the invention;

FIG. 2 shows a schematic view of an embodiment of a vehicle seat according to the invention;

FIG. 3 shows a schematic view of electrodes as they can be provided as part of various embodiments of a heating device according to the invention or a vehicle seat according to the invention.

The illustrated embodiments merely represent examples of how the invention can be configured and do not represent a final limitation.

The embodiments, examples and variants of the preceding paragraphs, the claims or the following description and the figures can be used independently of one another or in any combination. Features that are described in connection with an embodiment are applicable to all embodiments, provided that the features are not incompatible.

### DETAILED DESCRIPTION

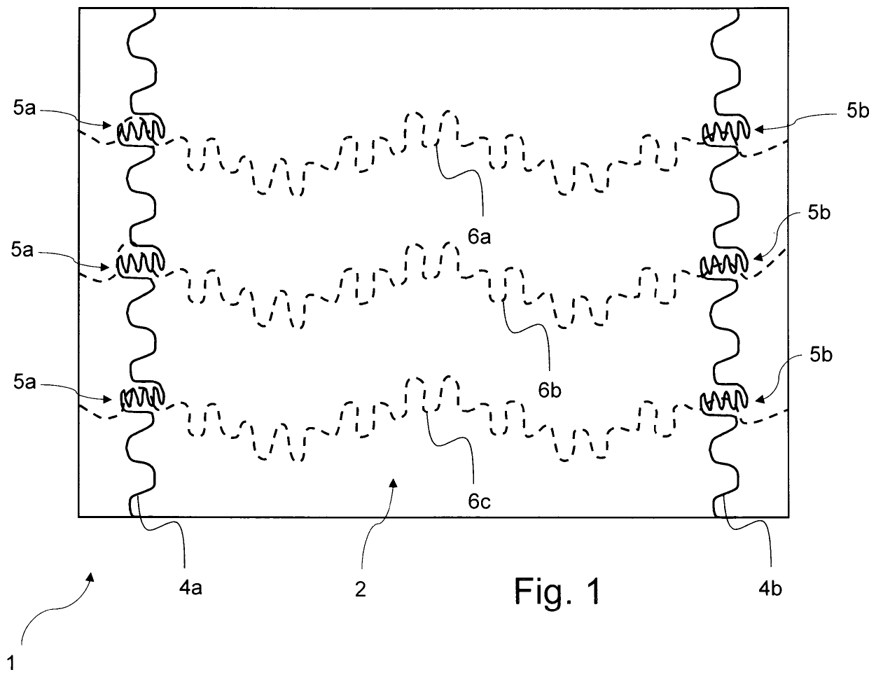

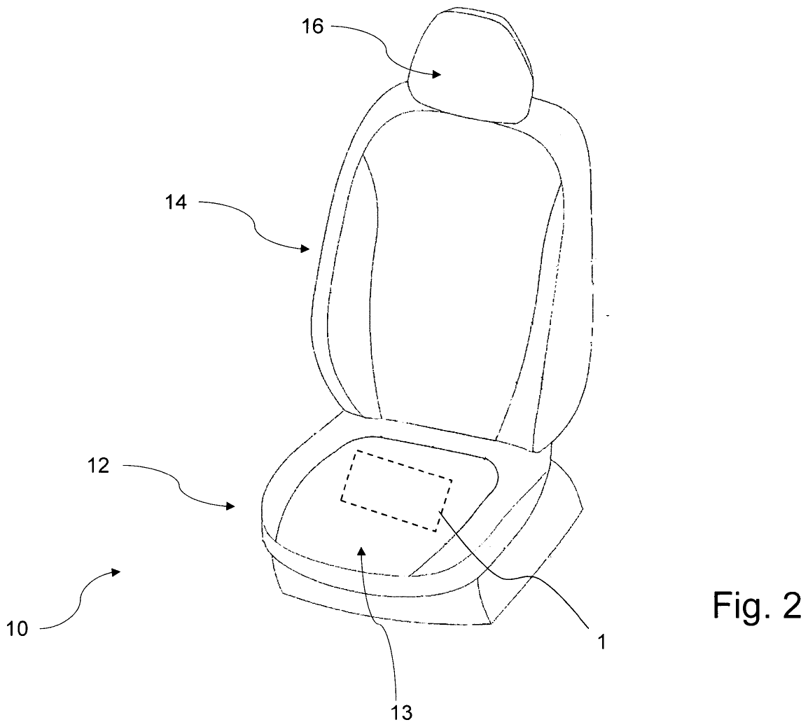

FIG. 1 shows a schematic view of an embodiment of a heating device 1 according to the invention. The heating device 1 is provided for temperature control or heating of a vehicle seat 10, as can be seen by way of example in FIG. 2. For this purpose, the heating device 1 comprises a substrate 2, which can be, for example, a textile construction and particularly a fleece. Two electrodes 4a and 4b fastened to the substrate 2 or sewn onto the substrate 2 are further shown. The electrode elements 4a and 4b are connected to an vehicle power supply which provides a nominal voltage of 48 volts.

The useful thermal energy of the heating device 1 is provided by a plurality of carbon fiber heating resistors 6a, 6b and 6c. The carbon fiber heating resistors 6a, 6b and 6c are each routed at an angle to the electrode elements 4a and 4b, wherein each heating element 6a, 6b, 6b meets the two electrode elements 4a and 4b in a respective contact region 5a and 5b. The carbon fiber heating resistors 6a, 6b and 6c are therefore electrically conductively connected to the two electrode elements 4a and 4b over a respective contact region 5a and 5b, respectively.

If voltage is applied to the two electrode elements 4a and 4b, the carbon fiber heating resistors 6a, 6b and 6c each emit useful thermal energy, whereby a vehicle seat 10 (see FIG. 2) can be heated. Depending on the heating power respectively required, the number and/or the routing of the carbon fiber heating resistors 6a, 6b or 6c can differ from the embodiment according to FIG. 1, so that the course and the number according to FIG. 1 are only to be understood as examples.

In heating devices known from the prior art, which provide useful thermal energy via carbon fiber heating resistors, a plurality of electrode elements are routed in order to be able to ensure reliable contact or a safe electrical connection between the carbon fiber heating resistors and the electrode element. The plurality of electrode elements required to date to ensure the electrical connection is associated with a high cost of materials. Such heating devices also have high costs due to the plurality of electrode elements required. In heating devices known from the prior art, each electrode element of the plurality of electrode elements must be connected to a substrate, so that undesirably high work effort is associated with the manufacture or production of a heating device known from the prior art.

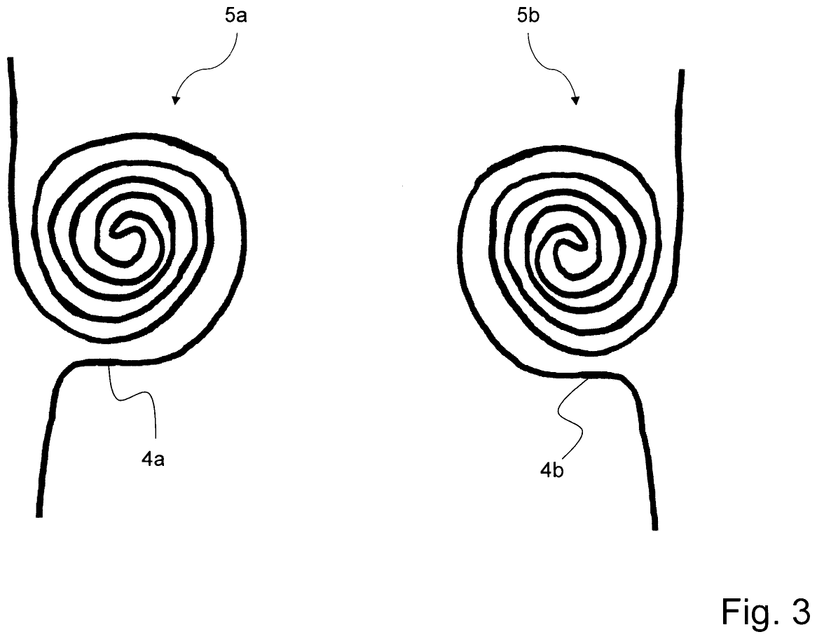

These disadvantages mentioned do not exist or only exist to a reduced extent in the heating device 1 from the embodiment according to FIG. 1. The heating device 1 has exactly two electrodes, or exactly two electrode elements 4a and 4b. The majority of the carbon fiber heating resistors 6a, 6b and 6c provided for the output of useful thermal energy run between the exactly two electrode elements 4a and 4b. As already mentioned above, each heating element 6a, 6b and 6b of the heating device 1 is electrically connected to the exactly two electrode elements 4a and 4b over contact regions 5a and 5b. FIG. 1 shows that the electrode elements 4a and 4b have a defined course in their respective contact region 5a and 5b, in which defined course the respective electrode 4a and 4b increases in area along a longitudinal direction of the respective heating element 6a, 6b and 6c. This enlargement of the area of the respective electrode 4a and 4b in the respective contact region 5a or 5b can keep very low the risk of an undesired loosening of an electrical connection between the respective electrode 4a and 4b and the respective heating element 6a, 6b or 6c in the respective contact region 5a or 5b. To increase the surface area in the longitudinal direction of the respective heating element 6a, 6b and 6c, in the embodiment according to FIG. 1, the two electrode elements 4a and 4b run in the respective contact region 5a and 5b in each case in a meandering shape along the longitudinal direction of the respective heating element 6a, 6b and 6c. To increase the surface area of the respective electrodes 4a and 4b, the electrode elements 4a and 4b in the respective contact region 5a and 5b can also have a course which differs from the meandering course according to FIG. 1. Purely by way of example, but not conclusively, reference should be made to the embodiment according to FIG. 3, wherein it is possible for an electrode 4a or 4b according to FIG. 3 to be provided as part of a heating device according to FIG. 1.

The electrode elements 4a and 4b run in a sinusoidally shape in FIG. 1 in all further regions which adjoin the respective contact region 5a and 5b. In further embodiments, it can alternatively be provided that the electrode elements 4a and 4b run in a straight line or at least approximately in a straight line in all further sections which adjoin the respective contact region 5a and 5b.

In practice, vehicle seats can form different heating zones which are predetermined for temperature control by means of a heating device. The electrode elements 4a and 4b can extend along a respective heating zone or be routed along a respective heating zone so that the respective heating zone can be correspondingly temperature controlled by means of a heating device 1. The shape or the course of the electrode elements 4a and 4b can therefore differ from a sinusoidal course according to FIG. 1 and from a straight course, so that further routing can be considered in order to be able to arrange a plurality of carbon fiber heating resistors 6a, 6b or 6c in the region of the respective heating zone. Since the electrodes or electrode elements 4a and 4b are flexible, their course or routing can be easily and simply adapted to the position of the respective heating zone. The electrode elements 4a and 4b can also have different orientations or courses in order to be able to connect the carbon fiber heating resistors 6a, 6b and 6c to the two electrode elements 4a and 4b.

In order to increase the stability of the heating device 1, the electrode elements 4a and 4b in the embodiment according to FIG. 1 are fixed or sewn onto the substrate 2 over the contact regions 5a and 5b.

FIG. 2 shows a schematic view of an embodiment of a vehicle seat 10 according to the invention. The vehicle seat 10 can, for example, be fastened in a passenger vehicle or be provided for installation in a passenger vehicle.

The vehicle seat 10 comprises a seat cushion 12 comprising a seat surface 13, a backrest 14 and a neck support 16. In the region of the seat surface 13, a heating device 1 is embedded in the seat cushion 12, so that the seat surface 13 can be heated via the heating device 1 embedded in the seat cushion 12. The heating device 1 is only indicated schematically in FIG. 2 and can be designed, for example, in accordance with the embodiment according to FIG. 1. The seat cushion 12 can comprise one or more optionally foamed layers (not shown), wherein the heating device 1 is connected to a layer and/or received or inserted therein in a receptacle which is formed by one of the a plurality of optionally foamed layers. The vehicle seat 10 can also comprise a cover which extends over the seat cushion 12, the backrest 14 and optionally also the neck support 16. FIG. 3 shows a schematic view of electrode elements 4a and 4b as they can be provided as part of various embodiments of a heating device 1 according to the invention (see FIG. 1) or a vehicle seat 10 according to the invention (see FIG. 2).

The electrode elements 4a and 4b can only be seen in some sections in the embodiment according to FIG. 3, wherein FIG. 3 only shows a single contact region 5a or 5b of a respective electrode 4a or 4b. According to the embodiment according to FIG. 1, the electrode elements 4a or 4b can have an associated contact region 5a or 5b for each heating element 6a, 6b or 6c, which contact region is designed in accordance with the contact region 5a or 5b shown in FIG. 3. In order to increase the surface area in the longitudinal direction of the respective heating element 6a, 6b or 6c, the electrode elements 4a and 4b in the embodiment according to FIG. 3 run in a spiral shape in the respective contact region 5a and 5b. In all further sections which adjoin the respective contact region 5a or 5b, the electrode elements 4a and 4b have a straight or at least approximately straight course, but can also run in a sinusoidal shape in further embodiments.

### LIST OF REFERENCE SYMBOLS

1 heating device
2 substrate
4a/4b electrode elements or electrodes
5 contact region
6a/6b/6c heating element
10 vehicle seat
12 seat cushion
13 seat surface
14 backrest
16 neck support

1. A heating device, comprising:
at least one heating element,
at least one electrode element,
a substrate on which the at least one electrode element and the at least one heating element are arranged,
wherein the at least one electrode element is arranged on the substrate in a first path and the at least one heating element is arranged on the substrate in a second path that is different than the first path,
wherein the first path of the at least one electrode element intersects the second path of the at least one heating element in at least one contact zone,
wherein the at least one electrode element and the at least one heating element in the at least one contact zone are electrically conductively connected to one another at a common contact surface, and
wherein the at least one electrode element and the at least one heating element intersect at least twice to achieve contact between the at least one electrode element and the at least one heating element at multiple points in the at least one contact zone and to increase the contact that is common to both of the at least one electrode element and the at least one heating element.

2. The heating device according to claim 1, wherein the heating device comprises at least one of the following features:
the at least one heating element is a flat structure,
the substrate is at least partially made of textile, fleece, foam, and/or film.

3. The heating device according to claim 1, wherein the heating device comprises at least one of the following features:
the at least one heating element is formed by an at least partially electrically conductive strand,
the at least one electrode element is formed by an at least partially electrically conductive strand.

4. The heating device according to claim 1, wherein the heating device comprises at least one of the following features:
the at least one heating element has a plurality of electrically conductive filaments arranged parallel to one another, twisted with one another and/or one after the other,
the at least one electrode element has a plurality of electrically conductive filaments arranged parallel to one another, twisted with one another and/or one after the other.

5. The heating device according to claim 1, wherein:
the heating device has two electrodes,
which are spaced apart from one another on the substrate,
which span a heating zone between them, and
which are electrically connected to one another via a plurality of heating elements, wherein the at least one electrode is formed from a single electrode element.

6. The heating device according to claim 1, wherein the heating device comprises a plurality of contact zones between the at least one electrode element or an electrode on the one hand and a plurality of heating elements along the at least one electrode element on the other hand.

7. The heating device according to claim 1, wherein the at least one heating element has only two contact zones, in a region of its respective ends.

8. The heating device according to claim 1, wherein the at least one electrode element runs in a meandering shape in the at least one contact region along a longitudinal direction of the at least one heating element.

9. The heating device according to claim 1, wherein the heating device comprises exactly two electrode elements are attached to the substrate and which comprises a plurality of heating elements that are carbon fiber heating resistors, wherein the exactly two electrode elements that are attached to the substrate are electrically conductively connected to the plurality of heating elements over a respective contact region.

10. The heating device according to claim 1, wherein the at least one electrode element runs at least approximately straight or at least approximately in a sinusoidal shape in a section adjoining the at least one contact region.

11. The heating device according to claim 1, wherein the at least one electrode element is attached to the substrate in the at least one contact region.

12. The heating device according to claim 1, wherein the at least one electrode element is sewn onto the substrate in the at least one contact region.

13. The heating device according to claim 1, wherein the at least one electrode element consists of copper or an alloy.

14. The heating device according to claim 1, wherein the at least one electrode element is formed by a plurality of filaments which each consist of a copper alloy, wherein
the at least one electrode element has a number n of filaments, for which number n applies: 5≤n≤125, and/or
each of these filaments has a cross-sectional diameter d, for which the following applies: 0.03 mm≤d≤0.12 mm

15. The heating device according to claim 1, wherein the heating device comprises a power source and/or a transformer, which are connected to at least two electrodes, attached to the substrate and which provide a nominal voltage of 48 volts.

16. A vehicle seat, comprising a seat cushion, a backrest, and the heating device according to claim 15, wherein the substrate, the at least two electrode elements, and the at least one heating resistor comprise carbon fiber components embedded in the seat cushion and/or in the backrest.
